(19) United States
(12) Patent Application Publication
(10) Pub. No.: US 2023/0420942 A1
(43) Pub. Date: Dec. 28, 2023

(54) FEEDSTOCK POWERED BLOCKCHAIN COMPUTATIONAL OPERATIONS

(71) Applicant: PoW-WoW Disruptor Holdings, LLC, Midland, TX (US)

(72) Inventor: Everett Willard Gray, II, Midland, TX (US)

(21) Appl. No.: 18/338,647

(22) Filed: Jun. 21, 2023

Related U.S. Application Data
(60) Provisional application No. 63/366,864, filed on Jun. 23, 2022.
(60) Provisional application No. 63/366,865, filed on Jun. 23, 2022.

(51) Int. Cl. H02J 3/14; H02J 3/00

(52) U.S. Cl. CPC H02J 3/144; H02J 3/003; H02J 2300/10

(57) ABSTRACT

Systems, devices, and methods are provided for powering blockchain computational operations, capable of achieving Proof-of-Work-Without-Waste (PoW-WoW). Techniques described herein may involve utilizing a feedstock of various fossil fuels to generate an electrical power output at a power generating facility of a microgrid. The microgrid may have the capability to operate independently from a main grid. The electrical power output may be utilized to operate blockchain computational operations of a computing center. Further, byproduct of the feedstock may be captured prepared for carbon capture sequestration (CCS) and/or carbon capture utilization storage (CCUS) to reduce or eliminate emissions.

### CROSS-REFERENCE TO RELATED APPLICATION(S)

This application claims priority to U.S. Provisional Patent Application No. 63/366,864 filed on Jun. 23, 2022, entitled “FEEDSTOCK POWERED BLOCKCHAIN COMPUTATIONAL OPERATIONS AND BYPRODUCTWASTE STREAM REMOVAL SYSTEMS AND METHODS”. This application claims priority to U.S. Provisional Patent Application No. 63/366,865 filed on Jun. 23, 2022, entitled “FEEDSTOCK POWERED BLOCKCHAIN COMPUTATIONAL OPERATIONS AND ENHANCED OILRECOVERY SYSTEMS AND METHODS”.

All of the applications listed above are hereby incorporated herein by reference in their entireties.

### TECHNICAL FIELD

Embodiments of the present disclosure relate generally to systems and methods for powering blockchain computational operations.

### BACKGROUND

Blockchain or other distributed ledger-type technologies may be used for a variety of purposes, including storing financial information related to cryptocurrency. A blockchain may include an immutable ledger that is shared and maintained across a distributed network. The immutable ledger may include blocks of information that are used to record a transaction, including transactions involving the exchange of certain cryptocurrencies. Users of the blockchain may execute subsequent transactions on the basis of an existing block of information. Information associated with the subsequent transactions may create a new block of information that is inextricably linked to the prior, existing block of data.

A given blockchain may be used to store transactions associated with cryptocurrency, including, but not limited to, Bitcoin, Ethereum, Dogecoin, Litecoin, and so on. In such blockchains, additional blocks are added to the blockchain, in part, by confirming and validating transactions using various computational operations, including, without limitation, a proof-of-work (PoW) operation, a Proof-of-Stake (PoS) operation, and others. In one example, the additional blocks may be added to the blockchain by generating a hash value (a long string of characters) that corresponds to the hash value of a particular block. The PoW operation, or other computational operation, then involves computationally complex, often energy intensive, calculations in order to generate said hash value, which can then be used to confirm and validate the transactions. Blockchain computational operations are often performed by users known as “miners.” Miners often pool vast amounts of computational resources to generate hash values. For cryptocurrency applications, the miners may be rewarded with newly minted cryptocoins and the like for compensation for the computational operations.

Blockchain related computational operations or mining may be substantially energy intensive. Such computational operations that draw power from on-grid sources may contribute to increased power costs and ultimately consume resources that may have detrimental environmental impacts.

Feedstocks, such as natural gas, coal, and/or other carbon or pollutant carrying feedstocks, may be used to generate electricity, including electricity that can be used in blockchain computational operations. In one example, natural gas or other feedstock may be used to fuel a turbine or other power generating equipment, such as a turbine in which the gas in burned to cause a rotatable component to rotate and produce electricity. Burning natural gas in power generating equipment also results in byproducts, such as carbon dioxide gas or other pollutants. Carbon dioxide gas is known to have a detrimental impact on the environment. As such, there is a need for systems and techniques that mitigate the environmental impacts associated with blockchain computational operations.

### BRIEF DESCRIPTION OF THE DRAWINGS

FIG. 1 depicts an example system for powering blockchain computational operations with a feedstock, in accordance with one or more example embodiments of the present disclosure.

FIG. 2 depicts a flow diagram of an example method for powering blockchain computational operations with a feedstock, in accordance with one or more example embodiments of the present disclosure.

FIG. 3 depicts another example system for powering blockchain computational operations with a feedstock, in accordance with one or more example embodiments of the present disclosure.

FIG. 4 depicts a flow diagram of another example method for powering blockchain computational operations with a feedstock, in accordance with one or more example embodiments of the present disclosure.

FIG. 5 depicts an example system for powering blockchain computational operations with a feedstock, in accordance with one or more example embodiments of the present disclosure.

FIG. 6 depicts a flow diagram of an example method for powering blockchain computational operations with a feedstock, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

Techniques described herein may be utilized to implement systems and methods for powering blockchain computational operations using various feedstocks. In some embodiments, carbon capture sequestration (CCS) technology is deployed to capture carbon dioxide (CO2) emissions and store the captured CO2. In some embodiments, carbon capture utilization storage (CCUS) technology is deployed to capture and then utilize the CO2 emissions. In some embodiments, the byproduct of the power generation is used to facilitate enhanced oil recovery operations.

The description that follows includes sample systems, methods, and apparatuses that embody various elements of the present disclosure. However, it should be understood that the described disclosure may be practiced in a variety of forms in addition to those described herein.

With the expansive growth and adoption of blockchain technologies across a wide range of industries, there is an increased awareness in the need to address environmental impacts of blockchain technologies while harnessing their potential benefits. In the United States alone, White House experts have estimated that the estimated electrical consumption for blockchain and crypto-assets is at approximately 25 to 50 million metric tons of carbon dioxide per year (Mt CO2/y), which would account for 0.4% to 0.8% of total U.S. greenhouse gas emissions.

The Biden Administration's “FACT SHEET: Climate and Energy Implications of Crypto-Assets in the United States” (https://www.whitehouse.goviostp/news-update s/2022/09/08/fact-sheet-climate-and-energy-implications-of-crypto-as sets-in-the-united-states/) highlights that while digital assets have provided benefits, their energy-intensive nature can result in significant greenhouse gas emissions and other environmental impacts. The report emphasizes the need to ensure the responsible development of digital assets in order to achieve clean energy goals.

The report identifies the dominant consensus mechanism for crypto-assets, called Proof-of-Work (PoW), as a major driver of energy consumption. Bitcoin and Ethereum, which together represent over 60% of the total crypto-asset market capitalization, have traditionally relied on PoW. Although Ethereum switched to a Proof-of-Stake (PoS) mechanism, this may not be an option for all blockchain networks, and has many potential drawbacks, such as:
Security Concerns: PoW is known for its strong security guarantees due to its high computational requirements. In a PoS system, the security of the network relies on the stake held by participants. Critics have argued that PoS is more vulnerable to attacks if a significant portion of the stake is concentrated in the hands of a few individuals or entities.
Centralization Risks: PoS systems often allocate mining power based on the stake held by participants. This can lead to centralization risks, where a small number of participants with significant stakes may have disproportionate influence over the network. Critics argue that this could undermine the decentralized nature of cryptocurrencies and potentially introduce governance issues.
Fairness Concerns: Some argue that PoS mechanisms may favor participants with larger stakes, leading to potential wealth concentration. This could create barriers to entry for smaller participants and reduce the inclusivity and decentralization that cryptocurrencies aim to achieve.
Potential for Manipulation: In a PoS system, participants can potentially influence the network by acquiring a large stake or controlling a significant portion of the cryptocurrency supply. This concentration of power could enable manipulation of transactions, block creation, or governance decisions.
Distribution of Rewards: In a PoW system, miners are rewarded based on the computational work they contribute. In a PoS system, rewards are typically distributed based on the stake held by participants. Critics argue that this could lead to a wealthier minority capturing a larger portion of the rewards, potentially exacerbating wealth inequality.

One of the important unsolved challenges described in the report is that renewable energy is presently unable to meet all of the needs for blockchain and crypto-asset related technologies. Accordingly, various embodiments described herein provide for solutions that involve the use of feedstocks to power blockchain computations while drastically reducing or eliminating byproduct.

In at least one embodiment of the present disclosure, Carbon Capture and Sequestration (CCS) technologies is utilized in the context of feedstock powered blockchain operations. A feedstock may refer generally to any process input to a power generation process that includes a pollutant. For example, the various feedstocks herein may include certain carbon-based fuels that are burned or otherwise processed by certain power generation processes to produce electric power used to power blockchain nodes. A CCS involves capturing said pollutant (e.g., carbon dioxide (CO2) emissions) and storing them (e.g., underground storage). CCS enables the capture and storage of CO2 emissions from blockchain mining operations, thereby reducing or eliminating the carbon footprint associated with the energy-intensive process. By preventing CO2 from being released into the atmosphere, CCS mitigates the contribution of blockchain mining to global greenhouse gas emissions, which can have a significant environmental impact especially in PoW systems. CCS can support the transition to renewable energy sources in the mining industry. As renewable energy sources become more prevalent, CCS can provide an interim solution for capturing and storing CO2 emissions from existing fossil fuel-based power generation used in crypto mining operations. This allows for a gradual shift towards cleaner energy sources while actively reducing the environmental impact of current operations.

In some cases, it may even be preferable to utilize feedstock powered blockchain operations over renewable energy. For example, Carbon Capture, Utilization, and Storage (CCUS) technologies involving the capture of carbon dioxide (CO2) emissions from industrial processes can be utilized to captured CO2 for beneficial purposes, resulting in both power generation and a useable byproduct. CO2 captured by a CCUS process can be used for beneficial purposes. Examples of CO2 utilization include: Enhanced Oil Recovery (EOR) applications, in which CO2 can be injected into oil reservoirs to enhance oil production; carbonation applications, in which CO2 can be reacted with minerals or industrial byproducts to produce carbonates, which can be used in construction materials; chemical feedstock applications, in which CO2 can be used as a raw material in the production of chemicals and fuels; food-grade carbonation in beverages, in which CO2 captured from industrial sources can be purified and used in carbonated beverages; and more. CO2 may be captured using CCUS technology and facilitate the growth of cannabis. For example, in controlled environments, CO2 tanks may be collected (e.g., from CCUS) and released into a cannabis growing area in a controlled manner. For cannabis, for example, the target CO2 level may in the range of 1,000 to 1,500 parts per million (PPM), which is higher than the levels of CO2 that are typically found in the atmosphere (typically, around 400 PPM). This CO enrichment can accelerate the photosynthesis in cannabis plants, thereby improving growth.

The following disclosure relates generally to systems and methods for powering blockchain computational operations using various feedstocks. As contemplated herein, such feedstock may generally be any process input to a power generation process that includes a pollutant. For example, the various feedstocks herein may include certain carbon-based fuels that are burned or otherwise processed by certain power generation processes to produce electric power. Example feedstocks include, without limitation, natural gas, including forms of renewable natural gas, coal, and other like fuels. In the example of natural gas, such natural gas may be sourced from substantially any natural gas source, including natural gas production wells, such as those of the Permian Basin. The natural gas is used to fuel certain power generating facilitates. In one example, the natural gas is burned to turn a turbine or other rotational component that in turn generates an electrical power output. Burning of the natural gas may also emit certain byproducts, including carbon dioxide, which is known to have certain detrimental environmental impacts.

The systems and methods herein are configured to power blockchain computational operations in a manner that reduces or substantially eliminates or eliminates waste gas byproduct, thereby enhancing the environmental impact of blockchain computational operations. Without limitation, as used herein, blockchain computational operations may include certain a proof-of-work (PoW) operations, a Proof-of-Stake (PoS) operations, and others. Described herein, the systems and methods of the present disclosure may operate to enhance the environmental impacts of computational operations. For example, the electrical power output of the natural-gas-run power generation facilities (and/or other facility in which the feedstock is used to generate power) may be used to power a computing center, such as a computing center that is engaged in computational operations. The power generation facilities may be systems or components of a microgrid that is electrically uncoupled or separate from a main consumer or industrial grid. As such, the computing center may be run on a power supply that does not draw from a main grid, which could otherwise weigh down the grid and contribute to energy price increases based on excess demand or load.

In some embodiments, the byproduct of the power generating facility, such as carbon dioxide, may be managed or mitigated or repurposed in a manner to reduce or substantially eliminate waste. In some examples, the byproduct carbon dioxide may be stored in a subsurface reservoir, such as a deep saline storage facility. In other examples, the byproduct carbon dioxide may be prepared for use in an industrial or commercial facility, such as one that uses carbon dioxide for carbonation. Accordingly, the byproduct carbon dioxide or other byproduct can be processed to produce a chemical product. Other example uses of the carbon dioxide are contemplated herein, including, but not limited to, use as a refrigerant, in fire extinguishers, for inflating life rafts and life jackets, blasting coal, forming certain rubbers and plastics, promoting growth of plants in greenhouses (including promoting the growth of algae), immobilizing animals before slaughter, and in carbonated beverages, among other uses.

In some embodiments, the byproduct of the power generating facility, such as carbon dioxide, may be used to facilitate enhanced oil recovery operations. For example, the byproduct may be processed in a manner that allows the byproduct to be injected into a subsurface reservoir to support enhanced oil recovery operations. In some cases, the byproduct may be a gas that is used to maintain or enhance subsurface reservoir pressure such that oil reserves are encouraged toward, and caused to flow from, a production well. The foregoing operations may result in the production or low carbon or even negative carbon oil. For example, a quantity of the produce oil may have a carbon content that is less than a carbon content of an associated quantity of the byproduct injected into the subsurface reservoir to produce the oil.

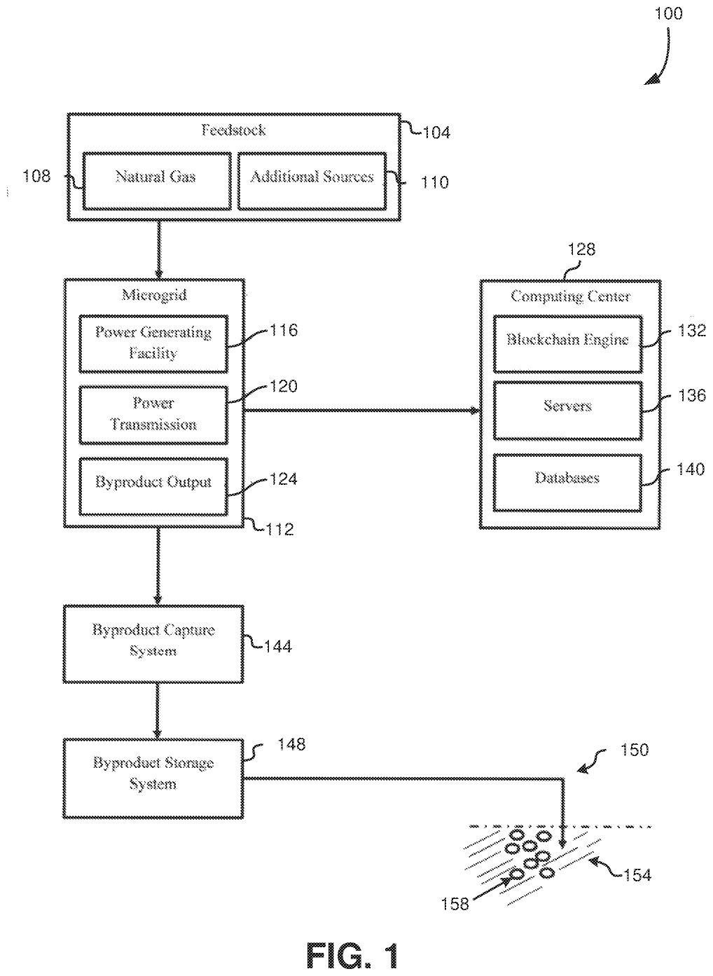

Turning to the drawings, for purposes of illustration, FIG. 1 depicts a system 100 for powering blockchain computational operations with a feedstock. In various embodiments, feedstocks discussed herein include feedstocks having pollutants. A feedstock having pollutants may refer to feedstocks that have or have the potential to contain substances that, when released into the atmosphere, can be considered pollutants. The system 100 includes a feedstock 104. In some examples, the feedstock 104 may include substantially any producible subsurface assets or coal refuse, including those associated with natural gas. In this regard, the feedstock 104 may be produced using natural gas 108, which may refer to natural gas from production wells, pipelines, liquefied natural gas, compressed natural gas, etc. The natural gas 108 may generally be configured to allow a flow of natural gas from the reservoir to a surface level for subsequent processing. Additionally or alternatively, the feedstock 104 may include additional sources 110. The additional sources 110 may include coal and/or substantially any other feedstock that can be used as a process input to a power generation facility to produce electrical power. The natural gas 108 (e.g., from the production wells or pipelines), the coal or other fuel from the additional sources 110 may include a pollutant, such as carbon dioxide.

The system 100 further includes a microgrid 112. The microgrid 112 may generally be configured to generate an electrical power output using a feedstock, such as the supply natural gas delivered from the natural gas 108 and/or the coal or other fuel delivered from the additional sources 110, such as coal refuse. The microgrid 112 may be off-grid or electrically uncoupled from a main commercial or residential grid. The microgrid 112 is shown in FIG. 1 as including a power generating facility 116. The power generating facility 116 may include, without limitation, certain turbines or other devices that are operative to generate an electrical power output using the feedstock. The power generating facility 116 may include turbines, as one example, which are configured to rotate upon burning of the natural gas. The rotation of the turbine is, in turn, used to generate an electrical power output. The microgrid 112 is further shown as including power transmission 120. The power transmission 120 may include transmission lines, distribution lines, and the like in order to route the electrical power output of the power generating facility 116 to a destination for consumption. The microgrid 112 is further shown as including a byproduct output 124. The byproduct output 124 may be associated with any output of the power generating facility 116, such as an output of carbon dioxide or other gas output from the operation of the power generating facility 116.

The system 100 is further shown in FIG. 1 as including a computing center 128. The computing center 128 may generally be any center that is configured to execute blockchain computational operations using the electrical power output of the power generating facility 116. Such computational operations may include those associated with PoW operations and/or Po S operations. The computing center 128 may therefore be electrically coupled with, and powered by, the microgrid 112 and may be physically located at any appropriate distance from the power generating facility 116, including in a remote location. The computing center 128 may include a blockchain engine 132. The blockchain engine 132 may be configured to execute any appropriate computing functions required to complete the computational operations, including those associated with generating hash values and like for given crypto currencies, including bitcoin. It will be appreciated that the computing center 128 may have any appropriate computing resources and components to facilitate the foregoing, including servers 136 and databases 140, shown in FIG. 1.

The system 100 may further include a byproduct capture system 144. The byproduct capture system 144 may be configured to capture byproducts output from the microgrid 112. For example, the byproduct capture system 144 may include certain vessels, compressors, flow lines, and the like that are configured to receive and process a stream of waste carbon dioxide from the microgrid 112. The byproduct capture system 144 may have sufficient capacity to capture and temporarily store carbon dioxide for any appropriate interval, including for several days or even months of operation of the microgrid 112, based on an ultimate power output of the power generating facility 116.

The system 100 may further include a byproduct storage system 148. The byproduct storage system 148 may be configured to store the byproduct in a subsurface reservoir 154, shown in FIG. 1. For example, the byproduct storage system 148 may receive a supply of the captured carbon dioxide gas from the byproduct capture system 144 and route the supply to an injection site 150. The injection site 150 may house or be associated with a deep saline storage facility. In turn, the byproduct storage system 148 may be configured to inject the supply of carbon dioxide into the deep saline storage facility using a class VI injector well and/or other appropriate well or technique, which may result in stored carbon dioxide 158 in the reservoir 154. In light of the foregoing, the computing center 128 may be operated on electrical power that has released no or little or substantially reduced carbon dioxide into the atmosphere, thereby enhancing the environmental impact of the computing center 128 operations.

In some embodiments, the power generation facilities of FIG. 1 may be systems or components of a microgrid that is electrically uncoupled or separate from a main consumer or industrial grid. As such, the computing center may be run on a power supply that does not draw from a main grid, which could otherwise weigh down the grid and contribute to energy price increases based on excess demand or load. In some embodiments, computing center 128 operates a blockchain node (e.g., a PoW node) that performs blockchain computational operations, such as hash operations to determine hash values as part of a PoW mining process. In various embodiments, the computing center 128 comprises dedicated circuitry for blockchain mining, for example, in the form of multiple graphics processing unit (GPUs) or application-specific integrated circuits (ASICs) that are configured for or otherwise adapted to perform the mining process. The power draw of such circuitry can be substantial. In some embodiments, the power generation facility will generate a variable electrical power output and the variable electrical power output is used to scale up or scale down the amount of dedicated circuitry that is operated. As more power is available on the microgrid, more GPUs and ASICS s may be commanded to perform hashing operations, and as less power is available on the microgrid, fewer GPUs and ASICs may be commanded to perform hashing operations. The variable electrical power output may be used to determine a target hashing rate, and the target hashing rate may be used to determine a target number of mining circuits to utilize, which in turn, may involve disabling one or more mining circuits until there is enough power to accommodate the operation of more mining circuits. In some embodiments, there is a target amount of byproduct that is to be generated (e.g., for CCUS applications) and the amount of mining circuits that are enabled is determined based on the estimated power output that would be needed to generate the target amount of byproduct.

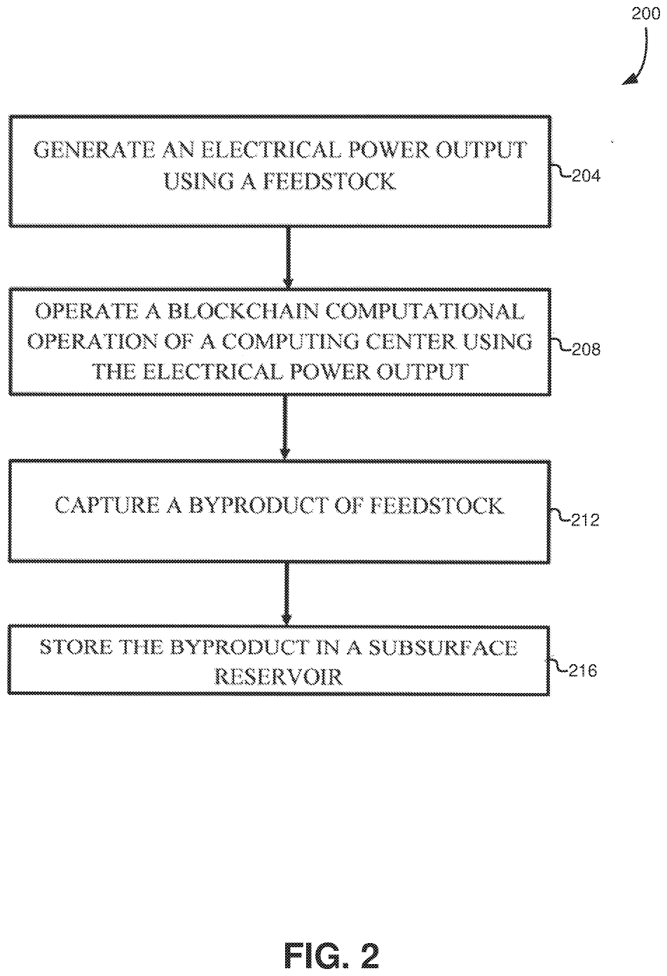

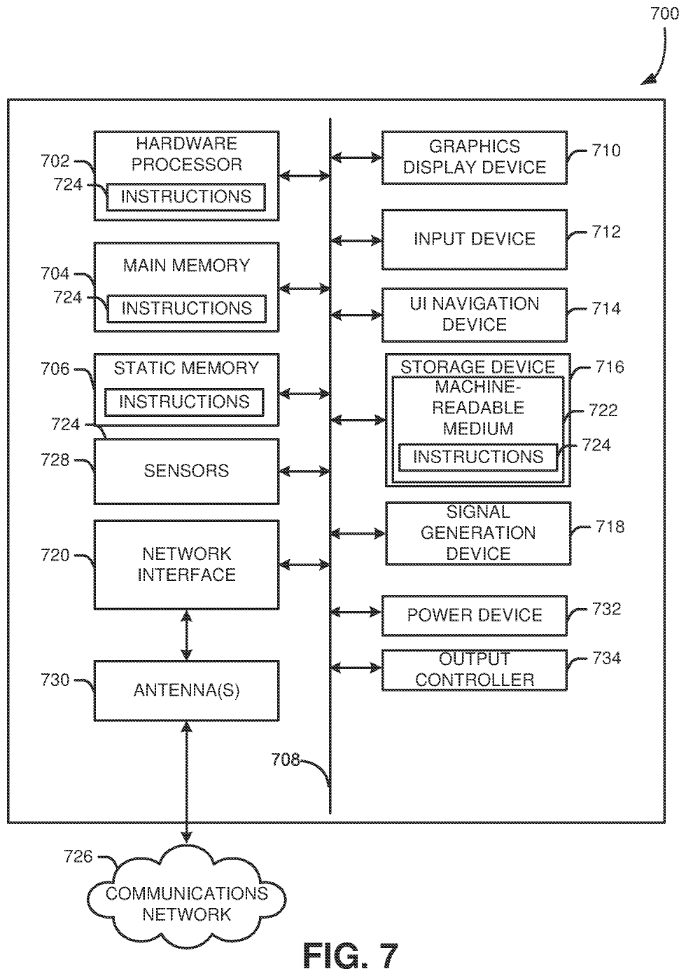

FIG. 2 shows an illustrative example of a process 200 for powering blockchain computational operations with natural gas, in accordance with one or more example embodiments of the present disclosure. In at least one embodiment, some or all of the process 200 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 200 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 200 may be implemented in the context of various systems and methods described elsewhere in this disclosure, such as those discussed in connection with FIGS. 1 and 7. In at least one embodiment, process 200 or a portion thereof is implemented within the context of a power generating facility that generates a power output and a byproduct. The power output may be used to operate a blockchain node and the byproduct is captured. In at least one embodiment, FIG. 2 depicts an illustrative process 200 for operating a proof-of-work-without-waste (PoW-WoW) blockchain node.

With reference to FIG. 2, a process 200 is shown for powering blockchain computational operations with natural gas. At operation 204, an electrical supply of power output is generated using a feedstock, such as one having certain pollutants. For example, and with reference to FIG. 1, the power generating facility 116 may generate the electrical supply of power using natural gas 108. At operation 208, a blockchain computational operation of a computing center is operated using the electrical power output. For example, and with reference to FIG. 1, the computing center 128 is operated using the electrical power output from the power generating facility 116 of the microgrid 112. At operation 212, a byproduct of the feedstock is captured, including a capture of at least some of the pollutant. For example, and with reference to FIG. 1, the byproduct capture system 144 may capture carbon dioxide emitted from the microgrid 112. At operation 216, the byproduct is stored in a subsurface reservoir. For example, and with reference to FIG. 1, the byproduct storage system 148 may inject carbon dioxide into the reservoir 154 or other deep saline storage facility.

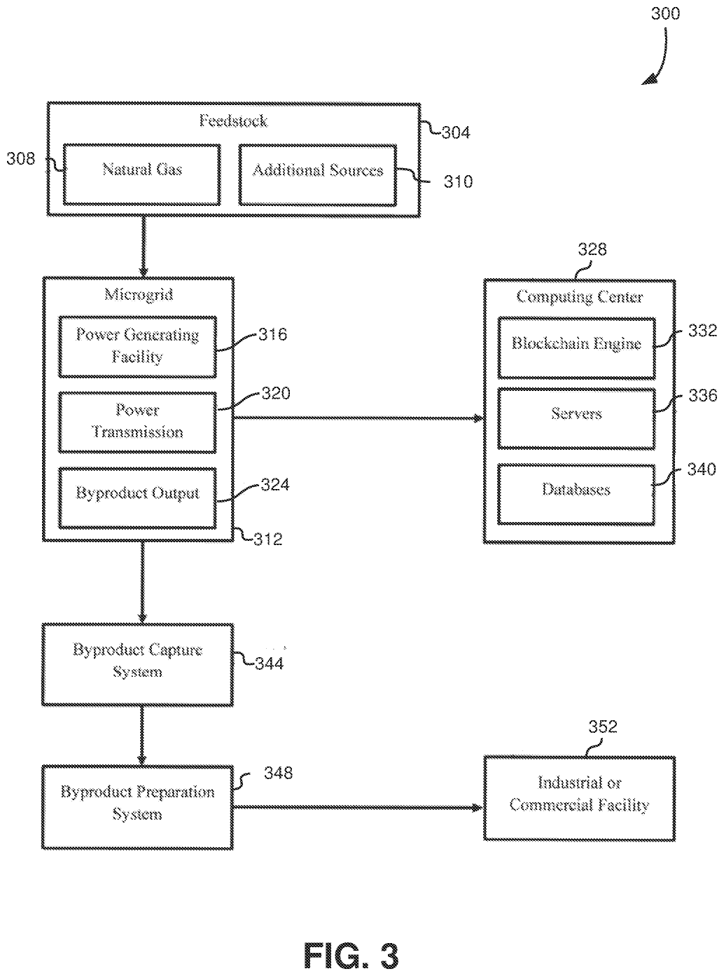

With reference to FIG. 3, a system 300 for powering blockchain computational operations with a feedstock is shown. The system 300 may be substantially analogous to the system 100 and include, feedstock 304, natural gas 308, additional sources 310, microgrid 312, power generating facility 316, power transmission 320, byproduct output 324, computing center 328, blockchain engine 332, servers 336, databases 340, byproduct capture system 344; redundant explanation of which is omitted herein for clarity.

Notwithstanding the foregoing similarities, the system 300 includes byproduct preparation system 348 and industrial or commercial facility 352. The byproduct preparation system 348 may include any appropriate process equipment configured to prepare the carbon dioxide gas for use in the industrial or commercial facility 352. For example, the byproduct preparation system 348 may include vessels, compressors, loading facilities, treatment columns, and the like that are configured to process the carbon dioxide gas for a particular use or to a particular standard, which may be set by the industrial or commercial facility 352. The byproduct preparation system 348 may be configured to, in some cases, cause a release of the carbon dioxide to a truck, railcar, pipeline or other transport mechanism for delivery of the carbon dioxide gas to the industrial or commercial facility 352. The industrial or commercial facility may receive the carbon dioxide gas and use it in any applicable industrial or commercial process. For example, the industrial or commercial facility process the byproduct to produce a chemical product. For the sake of non-limiting example, the carbon dioxide gas may be used to supply certain industries that required carbonation as a process input. In light of the foregoing, the computing center 328 may be operated on electrical power that has released no or little or substantially reduced carbon dioxide into the atmosphere, thereby enhancing the environmental impact of the computing center 328 operations.

In some embodiments, the power generation facilities of FIG. 3 may be systems or components of a microgrid that is electrically uncoupled or separate from a main consumer or industrial grid. As such, the computing center may be run on a power supply that does not draw from a main grid, which could otherwise weigh down the grid and contribute to energy price increases based on excess demand or load. In some embodiments, computing center 328 operates a blockchain node (e.g., a PoW node) that performs blockchain computational operations, such as hash operations to determine hash values as part of a PoW mining process. In various embodiments, the computing center 328 comprises dedicated circuitry for blockchain mining, for example, in the form of multiple graphics processing unit (GPUs) or application-specific integrated circuits (ASICs) that are configured for or otherwise adapted to perform the mining process. The power draw of such circuitry can be substantial. In some embodiments, the power generation facility will generate a variable electrical power output and the variable electrical power output is used to scale up or scale down the amount of dedicated circuitry that is operated. As more power is available on the microgrid, more GPUs and ASICS s may be commanded to perform hashing operations, and as less power is available on the microgrid, fewer GPUs and ASICs may be commanded to perform hashing operations. The variable electrical power output may be used to determine a target hashing rate, and the target hashing rate may be used to determine a target number of mining circuits to utilize, which in turn, may involve disabling one or more mining circuits until there is enough power to accommodate the operation of more mining circuits. In some embodiments, there is a target amount of byproduct that is to be generated (e.g., for CCUS applications) and the amount of mining circuits that are enabled is determined based on the estimated power output that would be needed to generate the target amount of byproduct.

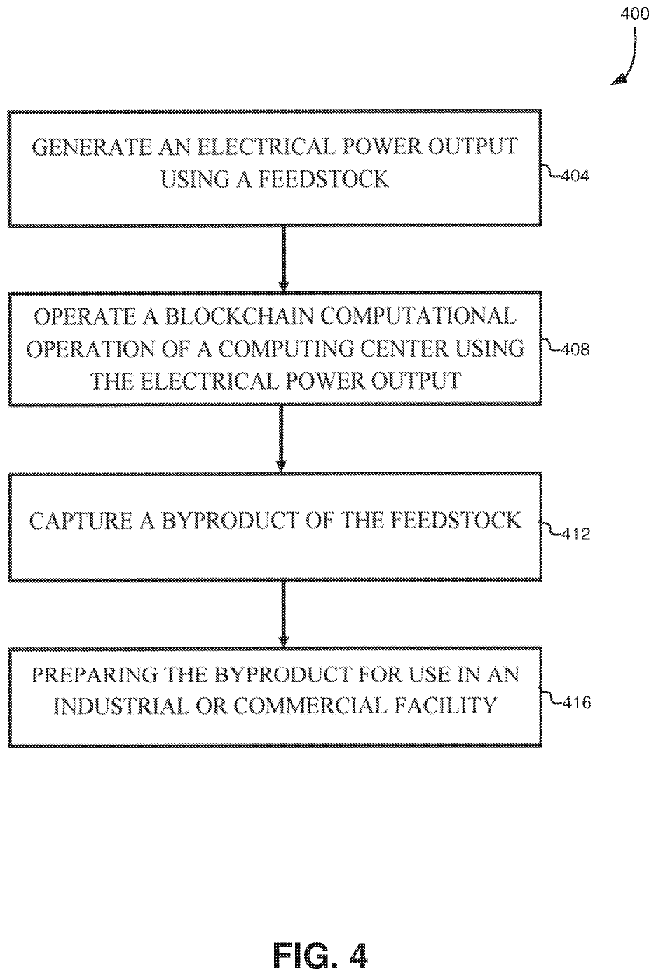

FIG. 4 shows an illustrative example of a process 400 for powering blockchain computational operations with a feedstock, in accordance with one or more example embodiments of the present disclosure. In at least one embodiment, some or all of the process 400 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 400 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 400 may be implemented in the context of various systems and methods described elsewhere in this disclosure, such as those discussed in connection with FIGS. 3 and 7. In at least one embodiment, process 400 or a portion thereof is implemented within the context of a power generating facility that generates a power output and a byproduct. The power output may be used to operate a blockchain node and the byproduct is captured. In at least one embodiment, FIG. 4 depicts an illustrative process 400 for operating a proof-of-work-without-waste (PoW-WoW) blockchain node.

With reference to FIG. 4, a process 400 is shown for powering blockchain computational operations with a feedstock. At operation 404, an electrical supply of power output is generated using a feedstock, including a feedstock having certain pollutants. For example, and with reference to FIG. 3, the power generating facility 316 may generate the electrical supply of power using natural gas 308 (e.g., from production wells or piped in). At operation 408, a blockchain computational operation of a computing center is operated using the electrical power output. For example, and with reference to FIG. 3, the computing center 328 is operated using the electrical power output from the power generating facility of the microgrid 312. At operation 412, a byproduct of a supply of natural gas is captured. For example, and with reference to FIG. 3, the byproduct capture system 344 may capture carbon dioxide emitted from the microgrid 312. At operation 416, the byproduct prepared for use in an industrial or commercial facility. For example, and with reference to FIG. 3, the byproduct preparation system 348 may cause or provide for the treatment and delivery of the carbon dioxide gas to the industrial commercial facility 352.

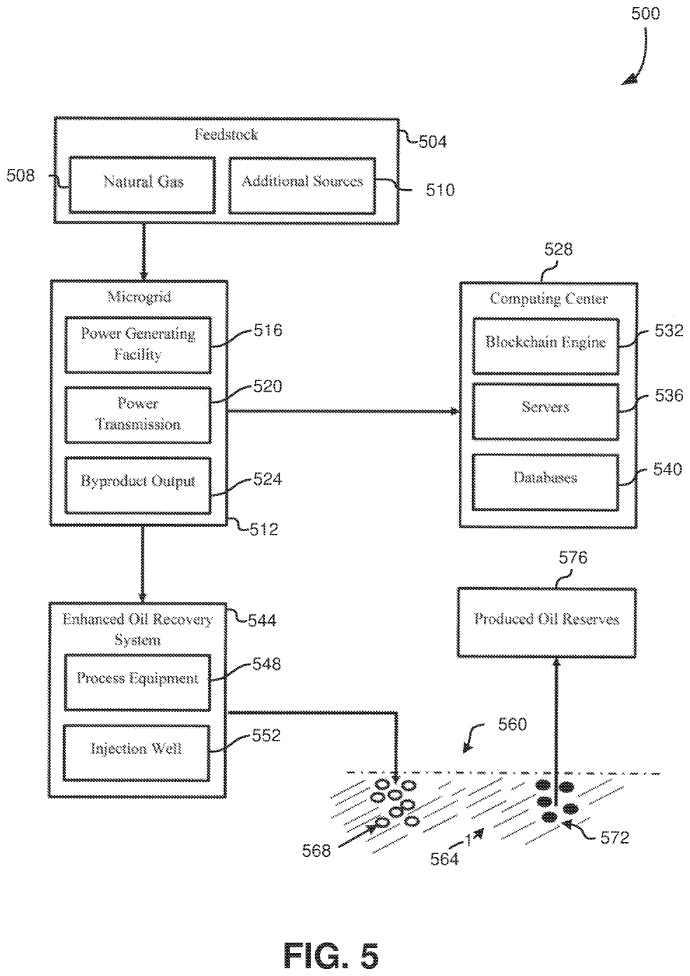

Turning to the drawings, for purposes of illustration, FIG. 5 depicts a system 500 for powering blockchain computational operations with a feedstock. The system 500 includes a feedstock 504. In some examples, the feedstock 504 may include substantially any producible subsurface assets, including those associated with natural gas, coal refuse, or others. In this regard, the feedstock 504 may be produced using natural gas 508. The natural gas 508 may generally be configured to allow a flow of natural gas from the reservoir to a surface level for subsequent processing. Additionally or alternatively, the feedstock 504 may include additional sources 510. The additional sources 510 may include coal and/or substantially any other feedstock that can be used as a process input to a power generation facility to produce electrical power. The natural gas 508, the coal or other fuel from the additional sources 510 may include a pollutant, such as carbon dioxide.

The system 500 further includes a microgrid 512. The microgrid 512 may generally be configured to generate an electrical power output using a feedstock, such as the supply natural gas delivered from the natural gas 508 and/or the coal or other fuel delivered from the additional sources 510. The microgrid 512 may be off-grid or electrically uncoupled from a main commercial or residential grid. The microgrid 512 is shown in FIG. 5 as including a power generating facility 516. The power generating facility 516 may include, without limitation, certain turbines or other devices that are operative to generate an electrical power using the feedstock. The power generating facility 516 may include turbines, as one example, which are configured to rotate upon burning of the natural gas. The rotation of the turbine is, in turn, used to generate an electrical power output. The microgrid 512 is further shown as including power transmission 520. The power transmission 520 may include transmission lines, distribution lines, and the like in order to route the electrical power output of the power generating facility 516 to a destination for consumption. The microgrid 512 is further shown as including a byproduct output 524. The byproduct output 524 may be associated with any output of the power generating facility 516, such as an output of carbon dioxide or other gas output from the operation of the power generating facility 516.

The system 500 is further shown in FIG. 5 as including a computing center 528. The computing center 528 may generally be any center that is configured to execute blockchain computational operations using the electrical power output of the power generating facility 516. Such computational operations may include those associated with PoW operations and/or PoS operations. The computing center 528 may therefore be electrically coupled with, and powered by, the microgrid 512 and may be physically located at any appropriate distance from the power generating facility 516, including in a remote location. The computing center 528 may include a blockchain engine 532. The blockchain engine 532 may be configured to execute any appropriate computing functions required to complete the computational operations, including those associated with generating hash values and like for given crypto currencies, including bitcoin. It will be appreciated that the computing center 528 may have any appropriate computing resources and components to facilitate the foregoing, including servers 536 and databases 540, shown in FIG. 5.

The system 500 may further include enhanced oil recovery system 544. The enhanced oil recovery system 544 may be configured to capture and process various byproducts from the microgrid and cause such byproducts to be used in enhanced oil recovery operations, including gas injection, thermal injection, steam flooding, fire flooding, and the like. Accordingly, the enhanced oil recovery system 544 is shown in FIG. 5 as including process equipment 548. The process equipment 548 may include various vessels, compressors, columns, distribution lines, and the like as may be required to capture and process the byproducts from the microgrid 512. For example, the process equipment 548 may include various components that are configured to capture carbon dioxide that is emitted from the power generating facility 516. In the case of gas injection enhanced oil recovery, the enhanced oil recovery system 544 may further include wells 552, such as a class II injection well.

As shown in FIG. 5, the enhanced oil recovery system 544 may be configured to transmit the gas byproduct to a field or site 560. The site 560 may house or be associated with a subsurface reservoir 564. The enhanced oil recovery system 544 may transmit the gas byproduct to the site 560 and use wells 552 (including class II wells) to provide injected gas 568 to the subsurface reservoir 564. The reservoir 564 may include oil reserves 572. The oil reserves 572 may be produced, in part, by the byproduct gas 568 maintaining or establishing a certain pressure in the reservoir 564 such that the oil reserves 572 are caused to flow to the surface and define produced oil reserves 576. The produced oil 576 may be considered low carbon or negative carbon oil. For example, the produced oil 576 may have a carbon content that is lesser than the carbon content of an associated quantity of gas byproduct injected into the reservoir 564. In light of the foregoing, the computing center 528 may be operated on electrical power that has released no carbon dioxide into the atmosphere, and in some cases operated on electrical power that, on net, has removed carbon dioxide from the atmosphere, thereby enhancing the environmental impact of the computing center 528 operations.

In some embodiments, the power generation facilities of FIG. 5 may be systems or components of a microgrid that is electrically uncoupled or separate from a main consumer or industrial grid. A microgrid may refer to a localized electrical system that can operate independently or in conjunction with the traditional power grid. A microgrid may be considered a small-scale version of the larger power grid, typically serving a specific facility or geographical area. In various embodiments, a microgrid can be configured to operate in a grid-connected mode and/or islanded mode. In grid-connected mode, the microgrid can draw electricity from the main grid when needed and also supply excess electricity back to the grid. This two-way flow of power enables energy sharing and optimization, contributing to overall grid resilience and stability. In islanded mode, the DERs within the microgrid can generate and distribute electricity locally, providing a reliable power supply to the connected loads, even when the microgrid is disconnected from the main grid, or if the man grid becomes unreliable or unreliable.

As such, the computing center may be run on a power supply that does not draw from a main grid, which could otherwise weigh down the grid and contribute to energy price increases based on excess demand or load. In some embodiments, computing center 528 operates a blockchain node (e.g., a PoW node) that performs blockchain computational operations, such as hash operations to determine hash values as part of a PoW mining process. In various embodiments, the computing center 528 comprises dedicated circuitry for blockchain mining, for example, in the form of multiple graphics processing unit (GPUs) or application-specific integrated circuits (ASICs) that are configured for or otherwise adapted to perform the mining process. The power draw of such circuitry can be substantial. In some embodiments, the power generation facility will generate a variable electrical power output and the variable electrical power output is used to scale up or scale down the amount of dedicated circuitry that is operated. As more power is available on the microgrid, more GPUs and ASICS s may be commanded to perform hashing operations, and as less power is available on the microgrid, fewer GPUs and ASICs may be commanded to perform hashing operations. The variable electrical power output may be used to determine a target hashing rate, and the target hashing rate may be used to determine a target number of mining circuits to utilize, which in turn, may involve disabling one or more mining circuits until there is enough power to accommodate the operation of more mining circuits. In some embodiments, there is a target amount of byproduct that is to be generated (e.g., for CCUS applications) and the amount of mining circuits that are enabled is determined based on the estimated power output that would be needed to generate the target amount of byproduct.

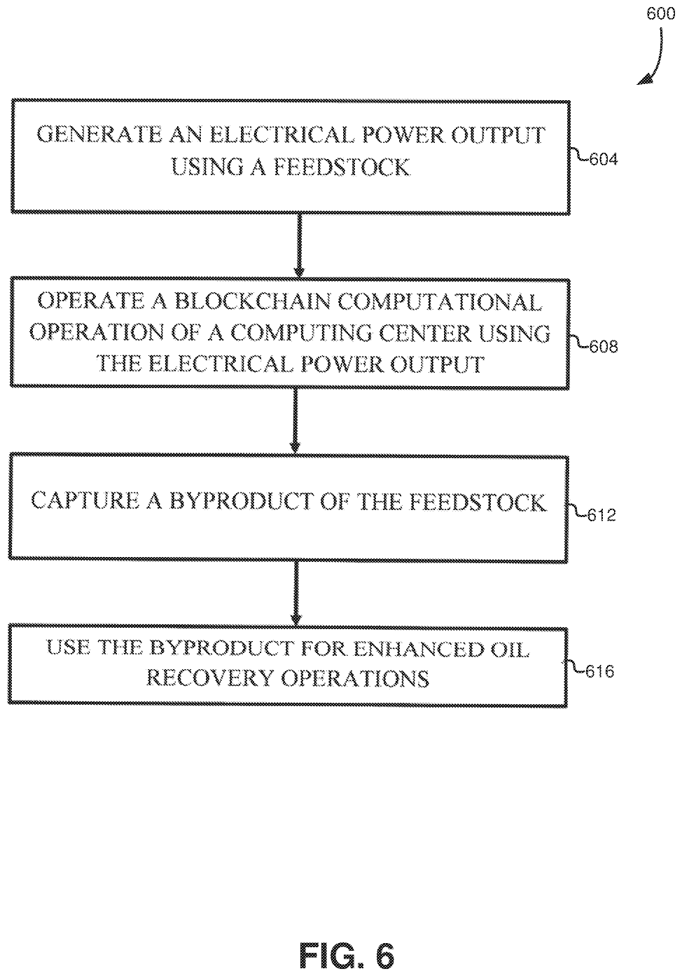

FIG. 6 shows an illustrative example of a process 600 for powering blockchain computational operations with a feedstock, in accordance with one or more example embodiments of the present disclosure. In at least one embodiment, some or all of the process 600 (or any other processes described herein, or variations and/or combinations thereof) is performed under the control of one or more computer systems that store computer-executable instructions and may be implemented as code (e.g., computer-executable instructions, one or more computer programs, or one or more applications) executing collectively on one or more processors, by hardware, software, or combinations thereof. The code, in at least one embodiment, is stored on a computer-readable storage medium in the form of a computer program comprising a plurality of computer-readable instructions executable by one or more processors. The computer-readable storage medium, in at least one embodiment, is a non-transitory computer-readable medium. In at least one embodiment, at least some of the computer-readable instructions usable to perform the process 600 are not stored solely using transitory signals (e.g., a propagating transient electric or electromagnetic transmission). A non-transitory computer-readable medium does not necessarily include non-transitory data storage circuitry (e.g., buffers, caches, and queues) within transceivers of transitory signals. Process 600 may be implemented in the context of various systems and methods described elsewhere in this disclosure, such as those discussed in connection with FIGS. 5 and 7. In at least one embodiment, process 600 or a portion thereof is implemented within the context of a power generating facility that generates a power output and a byproduct. The power output may be used to operate a blockchain node and the byproduct is captured. In at least one embodiment, FIG. 6 depicts an illustrative process 600 for operating a proof-of-work-without-waste (PoW-WoW) blockchain node.

With reference to FIG. 6, a process 600 is shown for powering blockchain computational operations with a feedstock. At operation 604, an electrical supply of power output is generated using a supply of feedstock having certain pollutants. For example, and with reference to FIG. 5, the power generating facility 516 may generate the electrical supply of power using natural gas 508. At operation 608, a blockchain computational operation of a computing center is operated using the electrical power output. For example, and with reference to FIG. 5, the computing center 528 is operated using the electrical power output from the power generating facility 516 of the microgrid 512. At operation 652, a byproduct of a supply of the feedstock is captured. For example, and with reference to FIG. 5, the byproduct capture system 544 may capture carbon dioxide emitted from the microgrid 512. At operation 656, the byproduct is used for enhanced oil recovery operations. For example, and with reference to FIG. 5, enhanced oil recovery system 544 may process and inject gas byproduct into the reservoir 564 in order to facilitate the production of produced oil reserves 576. The produced oil reserves may have a carbon content that is less than a carbon content of an associated quantity of byproduct injected to produce the reserves.

While FIG. 6 depicts an embodiment in which the byproduct is used for enhanced oil recovery operations, the environment of FIG. 6 may be adapted for other types of byproduct capture and utilization. For example, according to various embodiments, FIG. 6 may be adapted to implement various types of Carbon Capture, Utilization, and Storage (CCUS) technologies involving the capture of byproducts such as CO2 emissions for beneficial purposes. According to one example, byproduct in the form of CO2 emissions is captured and utilized for carbonation applications in which CO2 can be reacted with minerals or industrial byproducts to produce carbonates, which can be used in construction materials. According to one example, byproduct in the form of CO2 emissions is chemical feedstock applications, in which CO2 can be used as a raw material in the production of chemicals and fuels. According to one example, byproduct in the form of CO2 emissions is food-grade carbonation in beverages, in which CO2 captured from industrial sources can be purified and used in carbonated beverages.

In at least some embodiment, a “blockchain” or “blockchain network” refers to any and all suitable forms of distributed ledgers, which includes consensus-based blockchain and transaction-chain technologies, permissioned and un-permissioned ledgers, shared ledgers, and more. Non-limiting examples of blockchain technology include Bitcoin and Ethereum, although other examples of blockchain technologies are also contemplated in the scope of this disclosure. While Bitcoin and Ethereum may be described in connection with various embodiments of this disclosure, those embodiments are to be construed merely as illustrative examples and not limiting. For example, alternative blockchain implementations and protocols are contemplated within the scope of the present disclosure.

A blockchain network may refer to a peer-to-peer electronic ledger implemented as a decentralized system. A ledger may comprise multiple blocks wherein a genesis block is a first block of the ledger and all other blocks reference a previous block. In at least some embodiment, each block (except the genesis block) includes a hash of the previous block to which that block became chained together to create an immutable record of the block to the blockchain ledger which cannot be modified, deleted, or otherwise altered. A block may include one or more blockchain transactions. A blockchain transaction may refer to a data structure that encodes the transfer of control of a digital asset between users of the blockchain network. For example, a blockchain transaction may transfer control of a digital asset from a source address to a destination address. The blockchain transaction may be signed with a private key associated with the address which can be cryptographically verified using a corresponding public key that is made available to other parties of the blockchain network. In at least one embodiment a blockchain transaction includes a transaction input and a transaction output.

In some embodiment, a blockchain transaction is validated before it is committed to the blockchain ledger as part of a block. Blockchain nodes may be used to verify blockchain transactions, which may include verifying digital signatures of transactions, verifying that a purported owner of a digital asset is actually the owner by inspecting the blockchain ledger to verify that control of the digital asset was transferred to the purported owner and that the purported owner has not elsewhere transferred control of the digital asset (meaning that the purported owner was previous the owner of the digital asset but has previously transferred control to another entity).

Validity in the blockchain context may be consensus based, and a transaction may be considered valid if a majority of nodes agrees that the blockchain transaction is valid. In at least some embodiments, a blockchain transaction references an unspent transaction output (UTXO) that is used to validate the transaction by executing the UTXO locking and unlocking script. If the UTXO locking and unlocking script executes successfully (e.g., by evaluating to TRUE and any other validation operations). Accordingly, a blockchain transaction is written to a blockchain ledger when it is validated by a node that receives the transaction and is added to a new block by a node (e.g., miner) and actually mined by being added to the public ledger of past transactions. In at least some embodiment, a blockchain transaction is considered to be confirmed when a certain number of subsequent blocks are added to the blockchain ledger, whereinafter the blockchain transaction becomes virtually irreversible.

A blockchain transaction output may include a locking script that “locks” a digital asset by specifying a condition that is to be met in order for the encumbrance to be lifted or unlocked (e.g., to allow control of the digital asset to be transferred to another user). A locking script may be referred to as an encumbrance. An unlocking script may be a corresponding script that in combination with the locking script, removes an encumbrance on digital assets. A locking script and unlocking script may be combined to form executable code that, if executed to completion or to yield a specific result, indicates that the unlocking script is valid and that the encumbrance may be removed. For example, “scriptPubKey” is a locking script in Bitcoin and “scriptSig” is an unlocking script.

It should be noted that while blockchain technology is perhaps most widely known for its use cryptocurrency, there are many other applications for blockchain technologies for providing secure systems. A secure system may refer to a system in which functionality—such as the exchange of digital assets between two or more entities—is cryptographically verifiable. A secure system may be robust to failure. A secure system may be immutable such that information that is committed to the blockchain ledger cannot be unilaterally modified by an individual. A secure system may provide additional assurances, such as assurances of confidentiality, integrity, authenticity, and nonrepudiation. Confidentiality may refer to assurances that certain information is not made publicly available (e.g., the underlying identity of a blockchain address may be kept secret or unknown). Authenticity may refer to assurances that a message was created by a party purporting to be the author of the message. Integrity may refer to assurances that a received message was not modified either intentionally (e.g., by a malicious party) or unintentionally (e.g., as a result of signal loss during transmission) from its original form when the message was transmitted. Nonrepudiation may refer to assurances that a party that digitally signs a blockchain transaction cannot deny the authenticity of the transaction.

Mining may refer to the process of validating blockchain transactions along a blockchain network. Validating blockchain transactions may involve a process of securing and verifying blockchain transactions (e.g., organized as blocks) along a blockchain. Mining may be a process that helps maintain network security by ensuring that valid blocks are recorded on a blockchain ledger. Generally speaking, participants in a mining process can be rewarded for using computing resources (e.g., compute resources such as CPUs) to solve computational algorithms. Mining can be done in various ways. Proof-of-work (POW) and proof-of-stake (POS) consensus are two non-limiting examples of how mining can be done.

Proof-of-stake may refer to a consensus algorithm in which validators secure new blocks before they are added to a blockchain network. In a POS mining algorithm, a node may participate in the mining process by staking an amount of digital assets. The POS may be a deterministic concept that states individuals are allowed to mine or validate new blocks equal to proportionally to the amount staked—in other words, the more digital assets a node stakes, the greater mining power the node has. In some cases, greater mining power means that a node has more opportunity to validate blocks and be rewarded. Opportunity may refer to probabilistic opportunity, in which a probability p₁>p₂ does not necessarily guarantee that a first node with higher probability p₁ actually mines more than a second node with lower probability p₂ over a specific period of time. However, long-run, expected value of miners with larger staked amounts may be greater than those of miners with smaller staked amounts.

A node may become a miner by staking an amount of digital assets from the miner's blockchain wallet by transferring digital assets to a bound wallet. Miners, who may be called validators, delegates, or forgers, may be chosen or voted for randomly by holders of digital assets on the blockchain network. For a node to be chosen as a staker, the node needs to have deposited a certain amount or value of digital assets into a special staking wallet. In at least some embodiments, miners are entitled to forge or create new blocks proportional to the amount staked. In some embodiments, mining is managed by a service provider, which provides the computing resources that are needed to record new data to a ledger.

POS blockchain networks may have several important differences from POW blockchain networks. In general, anyone with enough digital assets can validate transactions on a blockchain network, and the benefits of specialized hardware such as application-specific integrated circuits (ASICs) is less pronounced than in POW blockchain networks. Generally speaking, POS blockchain networks may be more energy efficient and environmentally friendly than POW blockchain networks. Non-limiting examples of POS blockchain networks include: DASH; NEO; Lisk; Stratis; PIVX; OkCash; and more. Generally speaking, in a POW blockchain network, nodes with greater computing power are more likely to mine new blocks, whereas in POS blockchain networks, nodes with greater staking amounts are more likely to validators.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

According to at least one embodiment, a method for powering blockchain computational operations, comprises: generating an electrical power output using a feedstock associated with a fossil fuel; operating the blockchain computational operations of a computing center using the electrical power output; capturing a byproduct of the feedstock, the byproduct comprising at least a portion of pollutants produced by the generation of the electrical power output; and preparing the byproduct for carbon capture sequestration (CCS).

According to at least one embodiment, a method is described wherein the preparing of the byproduct comprises storing the storing the byproduct in a subsurface reservoir.

According to at least one embodiment, a method is described wherein the subsurface reservoir comprises a deep saline storage facility.

According to at least one embodiment, a method is described wherein the storing comprises injecting the byproduct into the subsurface reservoir using a class VI injector well.

According to at least one embodiment, a method further comprises producing oil reserves from the subsurface reservoir based, in part, on a reservoir pressure maintained by the injected byproduct and a quantity of the produced oil has a carbon content that is less than a carbon content of an associated quantity of the byproduct injected into the subsurface reservoir.

According to at least one embodiment, a method is described wherein the electrical power output is a variable electrical power output and the method further comprises: determining a value of the variable electrical power output; determining, based at least in part on the variable electrical power output, an amount of mining circuitry; and responsive to the determination of the amount of mining circuitry based at least in part on the variable electrical power output, disabling one or more mining circuitry of the computing center that is used in the operating of the blockchain computational operations.

According to at least one embodiment, a method is described wherein the feedstock comprises a supply of natural gas.

According to at least one embodiment, a method is described wherein the supply of natural gas is derived from oil and gas wells capable of producing natural gas.

According to at least one embodiment, a method is described wherein the feedstock comprises one or more of a supply of coal or coal refuse.

According to at least one embodiment, a method is described wherein the blockchain computational operations comprises one or both of proof-of-work operations or proof-of-stake operations.

According to at least one embodiment, a method of powering blockchain computational operations comprises: generating an electrical power output using a feedstock associated with a fossil fuel; operating the blockchain computational operations of a computing center using the electrical power output; capturing a byproduct of the feedstock, the byproduct comprising at least a portion of pollutants produced by the generation of the electrical power output; and preparing the byproduct for carbon capture utilization storage (CCUS).

According to at least one embodiment, a method is described further comprising using the byproduct for enhanced oil recovery operations.

According to at least one embodiment, a method is described further comprising using the byproduct for carbonation of minerals or industrial byproducts to produce carbonates.

According to at least one embodiment, a method is described further comprising purifying the byproduct to produce food-grade carbon dioxide.

According to at least one embodiment, a method is described wherein the electrical power output is a variable electrical power output and the method further comprises: determining a value of the variable electrical power output; determining, based at least in part on the variable electrical power output, an amount of mining circuitry; and responsive to the determination of the amount of mining circuitry based at least in part on the variable electrical power output, disabling one or more mining circuitry of the computing center that is used in the operating of the blockchain computational operations.

According to at least one embodiment, a method is described wherein the feedstock comprises a supply of natural gas.

According to at least one embodiment, a method is described wherein the supply of natural gas is derived from natural gas production wells.

According to at least one embodiment, a method is described wherein the feedstock comprises one or more of a supply of coal or another fossil fuel.

According to at least one embodiment, a method is described wherein the feedstock comprises a renewable natural gas.

According to at least one embodiment, a method is described wherein the blockchain computational operations comprises one or both of proof-of-work operations or proof-of-stake operations.

According to at least one embodiment, a method for powering blockchain computational operations with a feedstock is disclosed. The method includes generating an electrical power output using a feedstock having certain pollutants. The method further includes operating blockchain computational operations of a computing center using the electrical power output. The method further includes capturing a byproduct of the supply of natural gas. The byproduct includes said pollutants of the feedstock. The method further includes storing the byproduct in a subsurface reservoir.

According to at least one embodiment, a method is described wherein the byproduct may include carbon dioxide.

According to at least one embodiment, a method is described wherein the subsurface reservoir may include a deep saline storage facility.

According to at least one embodiment, a method is described wherein the operation of storing may include injecting the byproduct into the subsurface reservoir using a class VI injector well.

According to at least one embodiment, a method is described wherein the operation of generating may include generating the electrical power output on a microgrid. The microgrid may be configured to receive the supply of natural gas from natural gas production wells, from pipelines, or other receiving means.

According to at least one embodiment, a method is described wherein the feedstock includes a supply of natural gas.

According to at least one embodiment, a method is described wherein the supply of natural gas may be derived from natural gas production wells.

According to at least one embodiment, a method is described wherein the feedstock may include one or more of a supply of coal or another fossil fuel.

According to at least one embodiment, a method is described wherein the blockchain computational operations may include one or both of proof-of-work operations or proof-of-stake operations.

According to at least one embodiment, a method for powering blockchain computational operations with a feedstock is disclosed. The method includes generating an electrical power output using a feedstock having certain pollutants. The method further includes operating blockchain computational operations of a computing center using the electrical power output. The method further includes capturing a byproduct of the supply of natural gas. The byproduct includes at a least a portion of the pollutants. The method further includes preparing the byproduct for use in an industrial or commercial facility.

According to at least one embodiment, a method is described wherein the byproduct may include carbon dioxide.

According to at least one embodiment, a method is described wherein the industrial or commercial facility may include a manufacturing or assembly operation that utilizes carbon dioxide as a process input.

According to at least one embodiment, a method is described wherein the operation of preparing may include storing the byproduct in a vessel. The method may further include causing a release of the byproduct from the vessel to a truck, railcar, or pipeline.

According to at least one embodiment, a method is described wherein the operation of generating may include generating the electrical power output on a microgrid. The microgrid may be configured to receive the supply of natural gas from a natural gas production wells.

According to at least one embodiment, a method is described wherein the feedstock includes a supply of natural gas.

According to at least one embodiment, a method is described wherein the supply of natural gas may be derived from natural gas production wells.

According to at least one embodiment, a method is described wherein the feedstock includes one or more of a supply of coal or another fossil fuel.

According to at least one embodiment, a method is described wherein the feedstock includes a renewable natural gas.

According to at least one embodiment, a method is described wherein the blockchain computational operations include one or both of proof-of-work operations or proof-of-stake operations.

According to at least one embodiment, a method is described wherein the method further includes processing the byproduct in the industrial or commercial facility to produce a chemical product.

According to at least one embodiment, a system for powering blockchain computational operations with natural gas is disclosed. The system includes a microgrid comprising a power generating facility configured to generate an electrical power output using a supply of natural gas having certain pollutants. The system further includes a computing center configured to execute blockchain computational operations using the electrical power output. The system further includes a byproduct capture system configured to capture a byproduct of the feedstock. The byproduct includes at least a portion of the pollutants. The system further includes a byproduct storage system configured to store the by product in a subsurface reservoir.

According to at least one embodiment, a system is described wherein the byproduct may include carbon dioxide.

According to at least one embodiment, a system is described wherein the subsurface reservoir may include a deep saline storage facility.

According to at least one embodiment, a system is described wherein the byproduct storage system may include a class VI injector well configured to inject the byproduct into the subsurface reservoir.

According to at least one embodiment, a method is described wherein the feedstock includes a supply of natural gas.

According to at least one embodiment, a system is described wherein the blockchain computational operations include one or both of proof-of-work operations or proof-of-stake operations.

According to at least one embodiment, a system for powering blockchain computational operations with natural gas is disclosed. The system includes a microgrid comprising a power generating facility configured to generate an electrical power output using a feedstock having certain pollutants. The system further includes a computing center configured to execute blockchain computational operations using the electrical power output. The system further includes a byproduct capture system configured to capture a byproduct of the feedstock. The byproduct includes at least a portion of the pollutants. The system further includes a byproduct preparation system configured to prepare the byproduct for use in an industrial or commercial facility.

According to at least one embodiment, a system is described wherein the byproduct may include carbon dioxide.

According to at least one embodiment, a system is described wherein the industrial or commercial facility comprises a manufacturing or assembly operation that utilizes carbon dioxide as a process input.

According to at least one embodiment, a system is described wherein the feedstock includes a supply of natural gas.

According to at least one embodiment, a system is described wherein the blockchain computational operations includes one or both of proof-of-work operations or proof-of-stake operations.

According to at least one embodiment, a method of powering blockchain computational operations with a feedstock is disclosed. The method includes generating an electrical power output using a feedstock having certain pollutants. The method further includes operating blockchain computational operations of a computing center using the electrical power output. The method further includes capturing a byproduct of the supply of natural gas. The byproduct includes at least a portion of the pollutants. The method further includes using the byproduct for enhanced oil recovery operations.

According to at least one embodiment, a method is described wherein the byproduct may include carbon dioxide.

According to at least one embodiment, a method is described wherein the method may further include transporting the byproduct to an oilfield. The method may further include injecting the byproduct into a subsurface reservoir. In some cases, the operation of injecting may further include injecting the byproduct into the subsurface reservoir using a class II injection well.

According to at least one embodiment, a method is described wherein the method may further include producing oil reserves from the subsurface reservoir based, in part, on a reservoir pressure maintained by the injected byproduct.

In some cases, a quantity of the produced oil may have a carbon content that is less than a carbon content of an associated quantity of the byproduct injected into the subsurface reservoir.

According to at least one embodiment, a method is described wherein the feedstock includes a supply of natural gas.

According to at least one embodiment, a method is described wherein the supply of natural gas may be derived from natural gas production wells.

According to at least one embodiment, a method is described wherein the feedstock includes one or more of a supply of coal or another fossil fuel.

According to at least one embodiment, a method is described wherein the feedstock includes a renewable natural gas.

According to at least one embodiment, a method is described wherein the blockchain computational operations include one or both of proof-of-work operations or proof-of-stake operations.

According to at least one embodiment, a system for powering blockchain computational operations with a feedstock is disclosed. The system includes a microgrid comprising a power generating facility configured to generate an electrical power output using a feedstock having certain pollutants. The system further includes a computing center configured to execute blockchain computational operations using the electrical power output. The system further includes a byproduct capture system configured to capture a byproduct of the feedstock. The byproduct includes at least a portion of the pollutants. The system further includes an enhanced oil recovery system configured to use the byproduct for enhanced oil recovery operations.

According to at least one embodiment, a system is described wherein the byproduct may include carbon dioxide.

According to at least one embodiment, a system is described wherein the enhanced oil recovery system comprises a class II injection well configured to inject the byproduct into the subsurface reservoir. In this regard, the system may further include a production well configured to produce oil reserves from the subsurface reservoir based, in part, on a reservoir pressure maintained by the injected byproduct. In some cases, a quantity of the produced oil may have a carbon content that is less than a carbon content of an associated quantity of the byproduct injected into the subsurface reservoir.

According to at least one embodiment, a system is described wherein the enhanced oil recovery system may further include surface facilities configured to process and prepare the byproduct for injection in the subsurface reservoir. In some cases, the surface facilities may include one or more of distribution lines, vessels, or compressors.

According to at least one embodiment, a system is described wherein the feedstock includes a supply of natural gas.

According to at least one embodiment, a system is described wherein the blockchain computational operations includes one or both of proof-of-work operations or proof-of-stake operations.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. The machine 700 may be a wearable device or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine 700 (e.g., computer system) may include any combination of the illustrated components. For example, the machine 700 may include a hardware processor 702 (e.g., a central processing unit (CPU), a graphics processing unit (GPU), a tensor processing unit (TPU) including an artificial intelligence application-specific integrated circuit (ASIC), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a data signal), a network interface device/transceiver 720 coupled to antenna(s) 730, and one or more sensors 728, such as a sound detecting sensor (e.g., a microphone), accelerometers, magnetometers, location sensors, and the like. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, other sensors, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include DOCSIS, fiber optic, a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cable box, a wearable smart device, cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a wearable smart device, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, DOCSIS, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

All references, including publications, patent applications, and patents, cited are hereby incorporated by reference to the same extent as if each reference were individually and specifically indicated to be incorporated by reference and were set forth in its entirety.

What is claimed is:

1. A method for powering blockchain computational operations, comprising:
generating an electrical power output using a feedstock associated with a fossil fuel;
operating the blockchain computational operations of a computing center using the electrical power output;
capturing a byproduct of the feedstock, the byproduct comprising at least a portion of pollutants produced by the generation of the electrical power output; and
preparing the byproduct for carbon capture sequestration (CCS).

2. The method of claim 1, wherein the preparing of the byproduct comprises storing the storing the byproduct in a subsurface reservoir.

3. The method of claim 2, wherein the subsurface reservoir comprises a deep saline storage facility.

4. The method of claim 3, wherein the storing comprises injecting the byproduct into the subsurface reservoir using a class VI injector well.

5. The method of claim 4, further comprising producing oil reserves from the subsurface reservoir based, in part, on a reservoir pressure maintained by the injected byproduct and a quantity of the produced oil has a carbon content that is less than a carbon content of an associated quantity of the byproduct injected into the subsurface reservoir.

6. The method of claim 1, wherein the electrical power output is a variable electrical power output and the method further comprises:
determining a value of the variable electrical power output;
determining, based at least in part on the variable electrical power output, an amount of mining circuitry; and
responsive to the determination of the amount of mining circuitry based at least in part on the variable electrical power output, disabling one or more mining circuitry of the computing center that is used in the operating of the blockchain computational operations.

7. The method of claim 1, wherein the feedstock comprises a supply of natural gas.

8. The method of claim 7, wherein the supply of natural gas is derived from oil and gas wells capable of producing natural gas.

9. The method of claim 1, wherein the feedstock comprises one or more of a supply of coal or coal refuse.

10. The method of claim 1, wherein the blockchain computational operations comprises one or both of proof-of-work operations or proof-of-stake operations.

11. A method of powering blockchain computational operations, comprising:
generating an electrical power output using a feedstock associated with a fossil fuel;
operating the blockchain computational operations of a computing center using the electrical power output;
capturing a byproduct of the feedstock, the byproduct comprising at least a portion of pollutants produced by the generation of the electrical power output; and
preparing the byproduct for carbon capture utilization storage (CCUS).

12. The method of claim 11, further comprising using the byproduct for enhanced oil recovery operations.

13. The method of claim 11, further comprising using the byproduct for carbonation of minerals or industrial byproducts to produce carbonates.

14. The method of claim 13, further comprising purifying the byproduct to produce food-grade carbon dioxide.

15. The method of claim 11, wherein the electrical power output is a variable electrical power output and the method further comprises:
determining a value of the variable electrical power output;
determining, based at least in part on the variable electrical power output, an amount of mining circuitry; and
responsive to the determination of the amount of mining circuitry based at least in part on the variable electrical power output, disabling one or more mining circuitry of the computing center that is used in the operating of the blockchain computational operations.

16. The method of claim 11, wherein the feedstock comprises a supply of natural gas.

17. The method of claim 16, wherein the supply of natural gas is derived from natural gas production wells.

18. The method of claim 11, wherein the feedstock comprises one or more of a supply of coal or another fossil fuel.

19. The method of claim 11, wherein the feedstock comprises a renewable natural gas.

20. The method of claim 11, wherein the blockchain computational operations comprises one or both of proof-of-work operations or proof-of-stake operations.
